(19) United States
(12) Patent Application Publication
(10) Pub. No.: US 2026/0145960 A1
(43) Pub. Date: May 28, 2026

(54) ELECTRODE ACTIVE MATERIAL AND ALL SOLID BATTERY

(71) Applicant: TAIYO YUDEN CO., LTD., Tokyo (JP)

(72) Inventor: Taiki SUEMATSU, Takasaki-shi (JP)

(21) Appl. No.: 19/393,033

(22) Filed: Nov. 18, 2025

(30) Foreign Application Priority Data
Nov. 28, 2024 (JP) 2024-207360

(51) Int. Cl. C01G 33/00

(52) U.S. Cl. CPC C01G 33/006; C01P 2002/74; C01P 2006/40

(57) ABSTRACT

An electrode active material includes an anode active material that is expressed as a composition formula of Al₂Nb₅₀₋ₓMₓO₁₂₈ in which x satisfies 0<x<20 and M is a transition metal element of which a valence is 5 or more.

### CROSS-REFERENCE TO RELATED APPLICATION

This application is based upon and claims the benefit of priority of the prior Japanese Patent Application No. 2024-207360, filed on Nov. 28, 2024, the entire contents of which are incorporated herein by reference.

### FIELD

A certain aspect of the present invention relates to an electrode active material and an all solid battery.

### BACKGROUND

In recent years, all solid batteries have been used as secondary batteries with high energy density. These all solid batteries require smaller, lighter, higher capacity and high energy density, and are therefore developing high capacity and high output electrode active materials (see, for example, International Publication No. 2022/080083, International Publication No. 2022/185717, Japanese Patent Application Publication No. 2024-50182, and Appl. Mater. Interface. 2019; 11(6): 6089-6096.).

### SUMMARY OF THE INVENTION

According to an aspect of the present invention, there is provided an electrode active material including: an anode active material that is expressed as a composition formula of Al₂Nb₅₀₋ₓMₓO₁₂₈ in which x satisfies 0<x<20 and M is a transition metal element of which a valence is 5 or more.

According to an aspect of the present invention, there is provided an all solid battery including: an oxide-based solid electrolyte layer; a first electrode layer that is provided on a first main face of the oxide-based solid electrolyte layer and includes a cathode active material; and a second electrode layer that is provided on a second main face of the oxide-based solid electrolyte layer and includes the electrode as claimed in claim 1.

### BRIEF DESCRIPTION OF THE DRAWINGS

FIG. 1 illustrates a schematic cross section of a basic structure of an all solid battery;

FIG. 2 illustrates a schematic cross section;

FIG. 3 illustrates measurement results of XRD measurement;

FIG. 4 illustrates a schematic cross section of a stacked all solid battery;

FIG. 5 illustrates a schematic cross section of another all solid battery;

FIG. 6 illustrates a flowchart of a manufacturing method of an all solid battery; and

FIG. 7A and FIG. 7B illustrate a stacking process.

### DETAILED DESCRIPTION

While Al₂Nb₅₀O₁₂₈ has a high volume specific capacity, it is difficult to obtain high rate and high cycle characteristics, and has the problem of being easily reacted when fired with solid electrolytes at once.

A description will be given of an embodiment with reference to the accompanying drawings.

### Embodiment

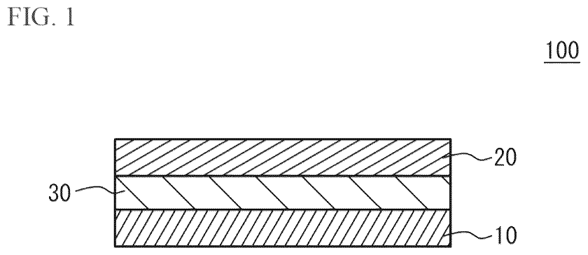

FIG. 1 illustrates a schematic cross section of a basic structure of an all solid battery 100 in accordance with a first embodiment. As illustrated in FIG. 1, the all solid battery 100 has a structure in which a first internal electrode 10 (a first internal electrode layer) and a second internal electrode 20 (a second internal electrode layer) sandwich a solid electrolyte layer 30. The first internal electrode 10 is provided on a first main face of the solid electrolyte layer 30. The second internal electrode 20 is provided on a second main face of the solid electrolyte layer 30. For example, the first internal electrode 10, the second internal electrode 20 and the solid electrolyte layer 30 have a sintered body which is formed by sintering powder materials.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphate-based electrolyte having a NASICON crystal structure. For example, the solid electrolyte of the solid electrolyte layer 30 is oxide-based solid electrolyte having lithium ion conductivity. The phosphate is not limited. For example, the phosphate is such as composite salt of phosphate with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphate is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like.

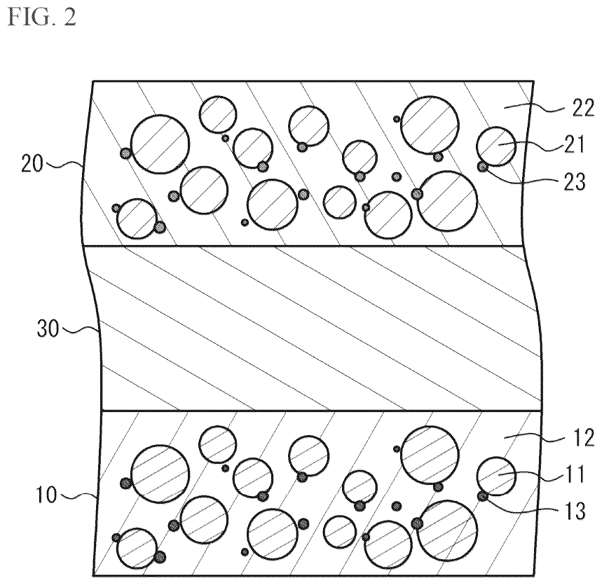

As illustrated in FIG. 2, the first internal electrode 10 has a structure in which an electrode active material 11, a solid electrolyte 12, a conductive aid 13 and the like are dispersed. The second internal electrode 20 has a structure in which an electrode active material 21, a solid electrolyte 22, a conductive aid 23 and the like are dispersed. The first internal electrode 10 includes the electrode active material 11 and the second internal electrode 20 includes the electrode active material 21, allowing the all solid battery 100 to be used as a secondary battery. The first internal electrode 10 includes the solid electrolyte 12 and the second internal electrode 20 includes the solid electrolyte 22, thereby achieving ion conductivity in the first internal electrode 10 and the second internal electrode 20. The first internal electrode 10 includes the conductive aid 13 and the second internal electrode 20 includes the conductive aid 23, thereby achieving electrical conductivity for the first internal electrode 10 and the second internal electrode 20. The solid electrolytes 12 and 22 may be, for example, the same solid electrolyte as the solid electrolyte layer 30, or may be different solid electrolytes.

The electrode active material 11 is, for example, an electrode active material having an olivine-type crystal structure. The electrode active material is such as a phosphate containing a transition metal and lithium. The olivine-type crystal structure is a crystal of a natural olivine, and can be determined by X-ray diffraction.

As a typical example of the electrode active material having an olivine-type crystal structure, LiCoPO₄ containing Co can be used. In this chemical formula, phosphates or the like, in which the transition metal Co is replaced, can also be used. Here, the ratio of Li and PO₄ may vary depending on the valence. It is preferred to use Co, Mn, Fe, Ni, or the like as the transition metal.

Carbon materials or the like are used as the conductive aids 13 and 23. Metals may be used as the conductive aids 13 and 23. An example of the conductive aid metal is such as Pd, Ni, Cu, Fe, or an alloy containing two or more of these.

Next, the anode active material contained in the electrode active material 21 will be described. The anode active material used in general Li-ion batteries is mainly graphite-based material. However, since the operating potential of the graphite-based material is close to the deposition potential of Li, there is a risk of internal short-circuit due to the deposition of Li during charging and discharging. Therefore, it is conceivable to use an oxide-based anode active material. Compared to graphite-based anode active materials, the operating potential of the oxide-based anode active materials has a higher operating potential and does not lead to lithium deposition, and therefore it is possible to provide a safe battery that does not cause internal short-circuits during charging and discharging. However, a drawback of the oxide-based anode active material is its low capacity.

In recent years, high capacity anode active materials such as AlNb₁₁O₂₉, which can input and output at about 270 mAh/g, have been reported. However, there is a need for an anode active material with a higher capacity than AlNb₁₁O₂₉. Therefore, it is conceivable to use Al₂Nb₅₀O₁₂₈, which has a volume specific capacity higher than AlNb₁₁O₂₉. However, Al₂Nb₅₀O₁₂₈ has the problem of difficulty in achieving high rate and high cycle characteristics, and also being easily reacted when fired with solid electrolytes at once.

Through intensive research by the present inventor, it has been discovered that an oxide in which part of Nb in Al₂Nb₅₀O₁₂₈ is replaced with a transition metal element (hereinafter referred to as transition metal element M) achieves a high volume specific capacity, as well as high rate and high cycle characteristics, and is difficult to react with solid electrolytes during firing. This is thought to be because when the transition metal element M is solidly dissolved (substituted) in the Nb site, lattice strain occurs, improving electrical properties, and because the oxide containing the transition metal element M is thermodynamically stable, element diffusion is difficult when co-fired with a solid electrolyte.

However, if the composition ratio of Nb decreases, there is a risk that a sufficient volume specific capacity will not be obtained. Therefore, in this embodiment, an upper limit is set to the content of the transition metal element M. Specifically, in this embodiment, an oxide expressed by the compositional formula of Al₂Nb₅₀₋ₓMₓO₁₂₈ and having x satisfying x of 0<x<20 is used as the anode active material. This enables a high volume specific capacity to achieve high rate and high cycle characteristics. Furthermore, since it is possible to fire together with a solid electrolyte over a wide firing temperature range, it is possible to provide an all solid battery using the anode active material.

From the viewpoint of sufficiently improving the rate and cycle characteristics, in the compositional formula of Al₂Nb₅₀₋ₓMₓO₁₂₈, x is preferably 3 or more, preferably 5 or more, and more preferably 10 or more.

From the viewpoint of achieving a sufficient volume specific capacity, in the compositional formula for Al₂Nb₅₀₋ₓMₓO₁₂₈, x is preferably less than 20, more preferably 18 or less, and even more preferably 15 or less.

As the transition metal element M, Ta, Ti, Ge, Zr, V, W, Mo or the like can be used.

The electrode active material 21 may contain an electrode active material other than the anode active material represented by the compositional formula Al₂Nb₅₀₋ₓMₓO₁₂₈, but it is preferred that the anode active material represented by the compositional formula Al₂Nb₅₀₋ₓMₓO₁₂₈ as the main component. For example, in the electrode active material 21, the anode active material represented by the compositional formula Al₂Nb₅₀₋ₓMₓO₁₂₈ is preferably 80% by volume or more, and more preferably 90% by volume or more.

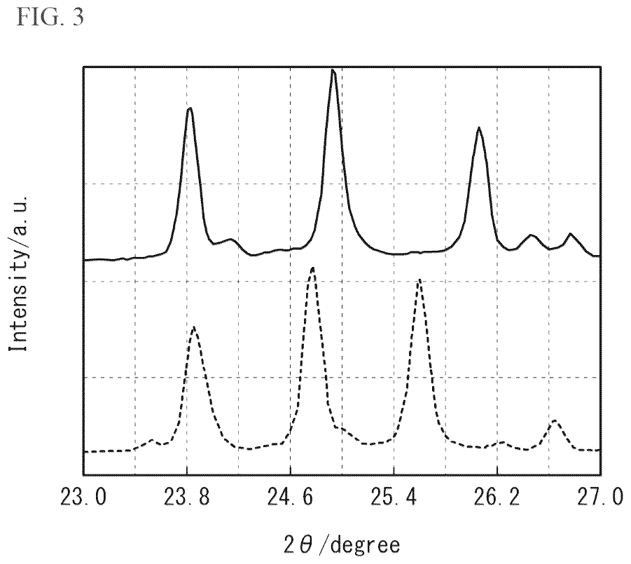

FIG. 3 is a diagram illustrating measurement results (solid line) when XRD measurements using CuKα rays for a anode active material having a composition of AlNb₁₁O₂₉ are performed, and measurement results (dotted line) when XRD measurements using CuKα rays for a anode active material having a composition of Al₂Nb₄₀Ta₁₀O₁₂₈ are performed. As illustrated in FIG. 3, for the anode active material having the composition of AlNb₁₁O₂₉, a peak appears in a range of 25.8° or more and 26.1° or less. In contrast, for the anode active material having a composition of Al₂Nb₄₀Ta₁₀O₁₂₈, no peaks appear in the range of 25.8° or more and 26.1° or less and but a peak appears in a range of 25.3° or more and 25.7° or less. In the anode active material represented by the compositional formula Al₂Nb₅₀₋ₓMₓO₁₂₈, the range of 25.8° to 26.1° is below the measurement limit, and no peak appears, while the peak appears in the range of 25.3° to 25.7°. Incidentally, “below the measurement limit” means that the intensity is 1/15 or less than the strongest peak in the range of 25.3° and 25.7°.

Therefore, when the electrode active material 21 includes an anode active material represented by the compositional formula Al₂Nb₅₀₋ₓMₓO₁₂₈, a peak appears in the range of 25.3° or more and 25.7° or less. Furthermore, when the electrode active material 21 does not contain an anode active material having a composition of AlNb₁₁O₂₉, the range of 25.8° or more and 26.1° or less is below the measurement limit and no peak appears.

If the average grain diameter of the electrode active material 21 is too large in the second internal electrode 20, the resistance within the electrode will be high, making it difficult to charge and discharge at high speed. If the average grain size is too small, it will not only increase reactivity during heat treatment, but it may also inhibit the sintering and densification of the solid electrolyte. Therefore, the average grain diameter of the electrode active material 21 in the second internal electrode 20 is preferably 0.5 μm or more and 5 μm or less, more preferably 0.7 μm or more and 4.5 μm or less, and even more preferably 1 μm or more and 4 μm or less.

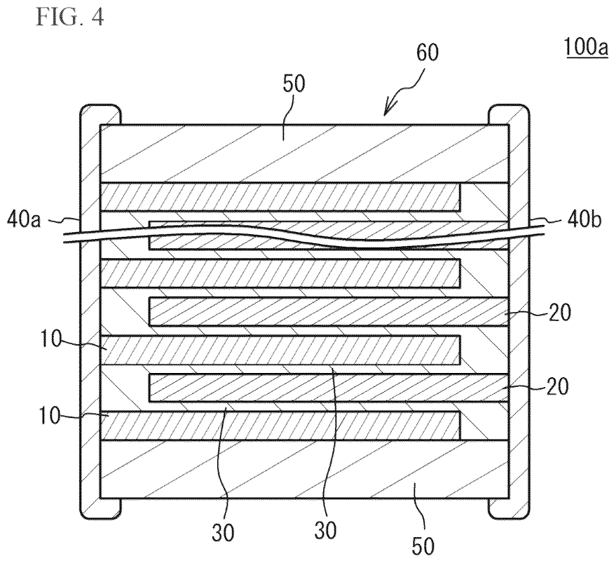

FIG. 4 is a schematic cross-sectional view of a stacked all solid battery 100a in which a plurality of battery units are stacked. The all solid battery 100a includes a multilayer chip 60 having a substantially rectangular parallelepiped shape. The multilayer chip 60 has a first external electrode 40a and a second external electrode 40b so as to contact two sides, one of the four surfaces other than the upper and lower surfaces of the multilayer chip 60 ends in the stacking direction. The multilayer chip 60 has the first external electrode 40a and the second external electrode 40b so as to contact two sides, one of the four surfaces other than the upper and lower surfaces of the stacking tip ends in the stacking direction. The two sides may be two adjacent sides, or two opposing sides. In this embodiment, it is assumed that the first external electrode 40a and the second external electrode 40b are provided so as to contact two opposing side surfaces (hereinafter referred to as two end surfaces).

In the following description, the same composition range, the same thickness range, and the same grain size distribution range as the all solid battery 100 are assigned the same reference numerals and detailed descriptions will be omitted.

In the all solid battery 100a, the plurality of first internal electrodes 10 and the plurality of second internal electrodes 20 are alternately stacked with the solid electrolyte layers 30 interposed therebetween. The edges of the plurality of first internal electrodes 10 are exposed on the first end face of the multilayer chip 60 and not on the second end face. The edges of the plurality of second internal electrodes 20 are exposed on the second end face of the multilayer chip 60 and not on the first end face. As a result, the first internal electrode 10 and the second internal electrode 20 are alternately conductive to the first external electrode 40a and the second external electrode 40b. The solid electrolyte layer 30 extends from the first external electrode 40a to the second external electrode 40b. In this way, the all solid battery 100a has a structure in which a plurality of battery units are stacked.

A cover layer 50 is stacked on the top surface of the multilayer structure of the first internal electrodes 10, the solid electrolyte layers 30, and the second internal electrodes 20 (in the embodiment of FIG. 4, the top surface of the topmost first internal electrode 10). The cover layer 50 is also laminated to the lower surface of the laminated structure (in the example of FIG. 4, the lower surface of the first internal electrode 10, which is the lowest layer). The cover layer 50 is mainly made of inorganic materials (for example, Al₂O₃, ZrO₂, TiO₂, or the like) containing, for example, Al, Zr, Ti, or the like. The cover layer 50 may contain the main component of the solid electrolyte layer 30 as its main component.

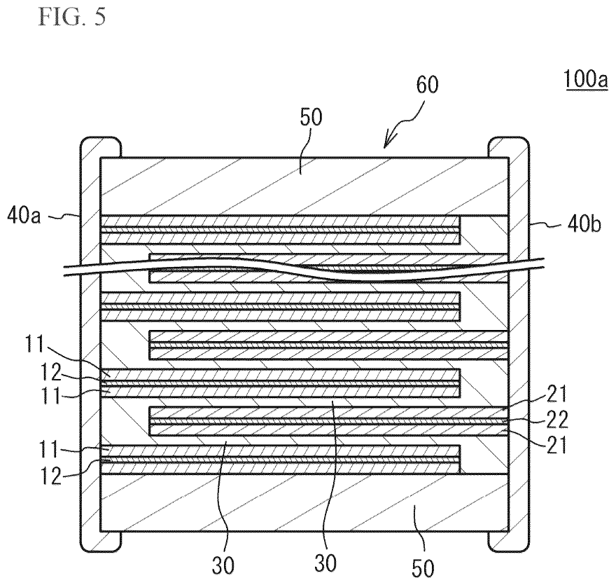

The first internal electrode 10 and the second internal electrode 20 may include a current collector layer. For example, as illustrated in FIG. 5, a first current collector layer 15 may be provided within the first internal electrode 10. Furthermore, a second current collector layer 25 may be provided within the second internal electrode 20. The first current collector layer 15 and the second current collector layer 25 are mainly composed of conductive materials. For example, metal, carbon or the like can be used as the conductive material for the first current collector layer 15 and the second current collector layer 25. The first current collector layer 15 is connected to the first external electrode 40a and the second current collector layer 25 is connected to the second external electrode 40b, thereby improving current collection efficiency.

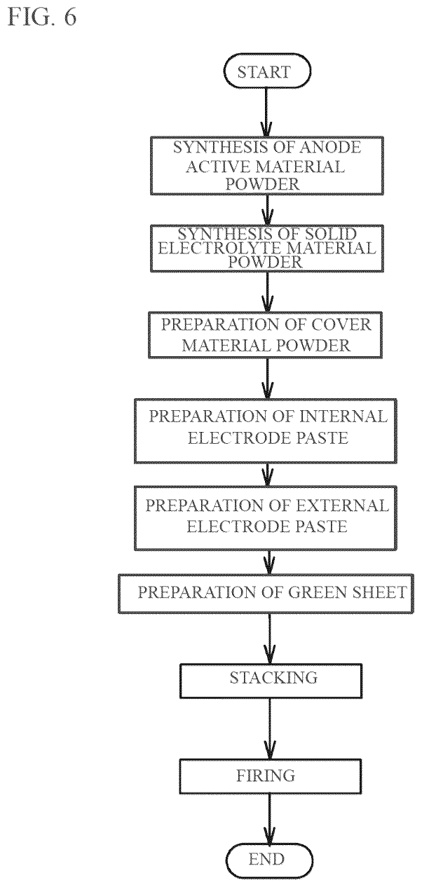

A description will be given of a manufacturing method of the all solid battery 100a described on the basis of FIG. 4. FIG. 6 illustrates a flowchart of the manufacturing method of the all solid battery 100a.

### (Synthesis Process of Anode Active Material Powder)

Raw materials such as Al₂O₃, Nb₂O₅, and oxides of transition metal element M are weighed and mixed. For example, the raw materials are weighed and mixed to obtain the compositional formula Al₂Nb₅₀₋ₓMₓO₁₂₈. After mixing, the mixture is calcined at 1100° C. in the normal atmosphere, and the obtained calcined powder is subjected to a re-crushing treatment. Thereafter, the mixture is heat treated in the atmosphere at a temperature of 1300° C. or higher to obtain the desired synthetic powder of Al₂Nb₅₀₋ₓMₓO₁₂₈ (0<x<20). After the synthetic powder is again crushed, it is sieved through a stainless steel mesh of #150 to form a powder material for the anode active material.

### (Synthesis Process of Solid Electrolyte Material Powder)

A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm φ.

### (Preparation Process of Cover Material Powder)

A raw material powder of ceramics for the cover layer 50 is made. For example, it is possible to make the raw material powder for the cover layer, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

### (Preparation Process of Internal Electrode Paste)

Next, internal electrode pastes for making the first internal electrode 10 and the second internal electrode 20 described above are separately made. For example, the internal electrode paste can be obtained by uniformly dispersing a conductive aid, an electrode active material, a solid electrolyte material, a sintering assistant, a binder, a plasticizer, and the like in water or an organic solvent. The above-mentioned solid electrolyte paste may be used as the solid electrolyte material. A carbon material or the like may be used as the conductive aid. A metal may be used as the conductive aid. An example of the metal of the conductive aid is such as Pd, Ni, Cu, Fe, or alloys containing these. Pd, Ni, Cu, Fe, alloys containing these, and various carbon materials may also be used. If the compositions of the first internal electrode 10 and the second internal electrode 20 differ from each other, the pastes for the internal electrodes may be prepared individually. Furthermore, when multiple types of anode active materials are included in the electrode active material 21 of the second internal electrode 20, the multiple types of anode active materials may be included in the internal electrode paste. At least the internal electrode paste for the second internal electrode 20 contains the powder raw material of the above-mentioned anode active material.

The sintering assistant includes one or more of glass components such as Li—B—O-based compound, Li—Si—O-based compound, Li—C—O-based compound, Li—S—O-based compound and Li—P—O-based compound.

### (Preparation Process of External Electrode Paste)

Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

### (Preparation Process of Green Sheet)

By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

### (Stacking Process)

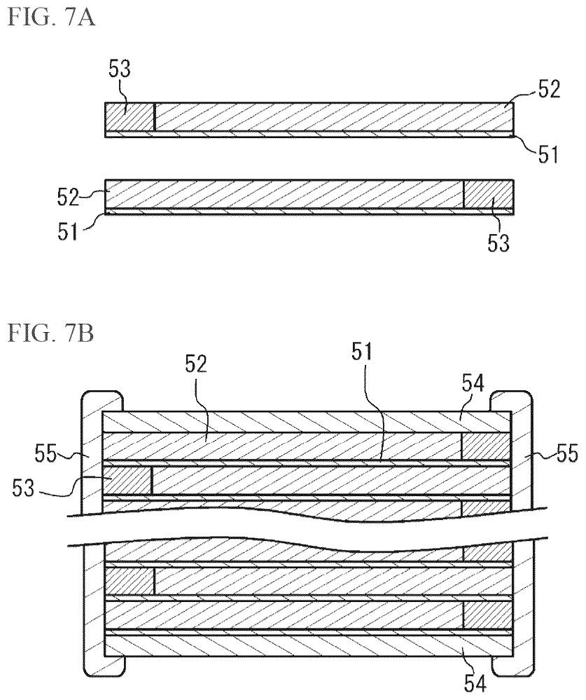

As illustrated in FIG. 7A, an internal electrode paste 52 is printed on one surface of the solid electrolyte green sheet 51. A reverse pattern 53 is printed on the peripheral area of the solid electrolyte green sheet 51 where the internal electrode paste 52 is not printed. The same material for the solid electrolyte green sheet 51 can be used as the reverse pattern 53. The solid electrolyte green sheet 51 after the printing can be used as a stack unit. The plurality of solid electrolyte green sheets 51 are stacked so as to be alternately shifted. As illustrated in FIG. 7B, a multilayer structure is obtained by pressing a cover sheet 54 from above and below in the stacking direction. In this case, in the multilayer structure, the internal electrode paste 52 for the first internal electrode 10 is exposed on one end surface, and the internal electrode paste 52 for the second internal electrode 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

### (Firing Process)

Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the first internal electrode 10 and the second internal electrode 20.

According to the manufacturing method according to this embodiment, since an anode active material having a compositional formula of Al₂Nb₅₀₋ₓMₓO₁₂₈ is used, the reaction between the anode active material and the solid electrolyte can be suppressed during the firing. As a result, the characteristics of Al₂Nb₅₀₋ₓMₓO₁₂₈ can be obtained in the all solid battery 100a, and a high volume specific capacity can be obtained, achieving high rate and high cycle characteristics.

### EXAMPLES

### Example 1

The raw materials were weighed to give a composition ratio of Al₂Nb₄₅Ta₅O₁₂₈ and mixed. After mixing, the mixture was calcined at 1000° C. in the normal atmosphere, the obtained calcined powder was again crushed, and then heated at 1300° C. in the normal atmosphere to obtain the desired synthetic Al₂Nb₄₅Ta₅O₁₂₈ powder. After the synthetic powder was again crushed, it was sieved through a stainless steel mesh of #150 to form an anode active material powder.

A coating slurry was prepared by mixing anode active material powder, PVdF binder, and acetylene black at a weight ratio of 80:10:10, and diluted with NMP, and then coating film was formed on an aluminum foil. A negative electrode half cell was constructed in which a metallic lithium foil was placed at the counter electrode with a separator interposed therebetween, and sealed in 2032 coin cells using EC:DEC (1:2 vol %) of 1M LiPF₆ as an electrolyte. DEC is diethyl carbonate. The EC is ethylene carbonate.

### Example 2

The raw materials were weighed to give a composition ratio of Al₂Nb₄₀Ta₁₀O₁₂₈ and mixed. The other conditions were the same as in Example 1.

### Example 3

The raw materials were weighed to give a composition ratio of Al₂Nb₃₅Ta₁₅O₁₂₈ and mixed. The other conditions were the same as in Example 1.

### Comparative Example 1

The raw materials were weighed to give a composition ratio of Al₂Nb₅₀O₁₂₈ and mixed. The other conditions were the same as in Example 1.

### Comparative Example 2

The raw materials were weighed to give a composition ratio of Al₂Nb₃₀Ta₂₀O₁₂₈ and mixed. The other conditions were the same as in Example 1.

### (Single-Phase Synthesis Rate)

For each of Examples 1 to 3 and Comparative Examples 1 and 2, the single-phase synthesis rate of the anode active material was measured. The single-phase synthesis rate was calculated from the ratio of the main phase and the second-order phase peak intensity obtained by Rietveld analysis. Specifically, the single-phase synthesis rate was defined as the strength of the anode active material/(strength of the anode active material+strength of the secondary phase)×100. The single-phase synthesis rate was 100% in Example 1, 100% in Example 2, 90% in Example 3, 100% in Comparative Example 1, and 46% in Comparative Example 2.

If the single-phase synthesis rate is 90% or more, the single-phase synthesis rate is judged as acceptable “∘”, and if the single-phase synthesis rate is less than 90%, the single-phase synthesis rate is judged as unacceptable “x”. The single-phase synthesis rates of Examples 1 to 3 and Comparative Example 1 were judged as acceptable “∘”. On the other hand, the single phase ratio of Comparative Example 2 was judged as unacceptable “x”. This is because it is thought that the discharge capacity will decrease if a large amount of the main phase (a material having a major peak between 25.3° and 25.7°) is included.

(Reaction Temperature with Solid Electrolyte)

The reaction temperature with the solid electrolyte was measured for each of Examples 1 to 3 and Comparative Examples 1 and 2. Specifically, an experiment was conducted in which the anode active material powder was mixed with solid electrolyte LAGP at a volume ratio of 50:50 and heat treatment was performed, and the temperature at which a different phase began to form was measured as the reaction temperature with the solid electrolyte. The reaction temperature with the solid electrolyte was 700° C. in Example 1, 710° C. in Example 2, 720° C. in Example 3, 640° C. in Comparative Example 1, and 720° C. in Comparative Example 2.

If the reaction temperature with the solid electrolyte is 700° C. or higher, the reaction temperature with the solid electrolyte is judged as acceptable “∘” and if the reaction temperature with the solid electrolyte is less than 700° C., the reaction temperature with the solid electrolyte is judged as unacceptable “x”. In Examples 1 to 3 and Comparative Example 2, the reaction temperature with the solid electrolyte was judged as acceptable “∘”. This is thought to be because part of Nb was replaced with Ta, making it difficult to react with the solid electrolyte. On the other hand, in Comparative Example 1, the reaction temperature with the solid electrolyte was judged as unacceptable “x”. This is thought to be because Nb was not replaced with Ta, which made it easier to react with the solid electrolyte.

### (Discharge Capacity)

A discharge capacity was measured for each of Examples 1 to 3 and Comparative Examples 1 and 2. The discharge capacity was measured by performing a CC charge/discharge of 0.2 C in a constant temperature bath at 25° C. with a cutoff potential of 1.0V-3.0V (vs.Li/Li+). The discharge capacity was 1145 mAh/cm³ in Example 1, 1063 mAh/cm³ in Example 2, 1049 mAh/cm³ in Example 3, 1312 mAh/cm³ in Comparative Example 1, and 342 mAh/cm³ in Comparative Example 2.

If the discharge capacity is 1000 mAh/cm³ or more, the discharge capacity is judged as acceptable “∘”, and if the discharge capacity is less than 1000 mAh/cm³, the discharge capacity is judged as unacceptable “x”. The discharge capacity of Examples 1 to 3 and Comparative Example 1 was judged as acceptable “∘”. On the other hand, the discharge capacity of Comparative Example 2 was judged as unacceptable “x”. This is thought to be because the capacity was reduced due to the replacement of much of the Nb with Ta.

### (Cycle Characteristics)

Cycle characteristic was measured for each of Examples 1 to 3 and Comparative Examples 1 and 2. The cycle characteristic was evaluated by 30 cycles of CC charge and discharge of 0.2 C in a constant temperature bath at 25° C., with a cutoff potential of 1.0V-3.0V (vs.Li/Li+), and then calculating the capacity retention rate from the initial discharge capacity. The capacity retention rate after 30 cycles was 91.3% in Example 1, 94.8% in Example 2, 94.4% in Example 3, 88.4% in Comparative Example 1, and 68.5% in Comparative Example 2.

If the capacity retention rate after 30 cycles is 90% or more, the cycle characteristic is judged as acceptable “∘”, and if the capacity retention rate after 30 cycles is less than 90%, the cycle characteristic is judged as unacceptable “x”. The cycle characteristic of Examples 1 to 3 was judged as acceptable “∘”. On the other hand, the cycle characteristic of Comparative Example 1 was judged as unacceptable “x”. This is thought to be because Nb is not replaced with Ta, and the cycle characteristic is not improved. In Comparative Example 2, the cycle characteristic was judged as unacceptable “x”. This is thought to be because most of the Nb was replaced with Ta, resulting in a significant decrease in the single-phase synthesis rate, resulting in significant cycle deterioration of the electrode.

### (Rate Characteristic)

Rate characteristic was examined for each of Examples 1 to 3 and Comparative Examples 1 and 2. Specifically, the capacity ratio to 0.5 C discharge at a discharge rate of 5 C was measured. The rate characteristic was 73.3% in Example 1, 75.1% in Example 2, 74.6% in Example 3, 68.7% in Comparative Example 1, and 47.6% in Comparative Example 2.

If the rate characteristic is 70% or more, the rate characteristic is judged as acceptable “∘”, and if the rate characteristic is less than 70%, the rate characteristic is judged as unacceptable “x”. The rate characteristic of Examples 1 to 3 was judged as acceptable “∘”. On the other hand, the rate characteristic of Comparative Example 1 was judged as unacceptable “x”. This is thought to be because Nb is not replaced with Ta, and the rate characteristic is not improved. In Comparative Example 2, the rate characteristic was judge as unacceptable “x”. This is thought to be because much of the Nb was replaced with Ta, resulting in significant deterioration in rate characteristic of the electrode.

### (Overall Judgment)

If the single-phase synthesis rate, the reaction temperature with solid electrolyte, the discharge capacity, the cycle characteristic, and the rate characteristic are judged as acceptable “∘”, the overall judgment is judged as acceptable “∘”. If any one of the above results is judged as unacceptable “x”, the overall judgment is judged as unacceptable “x”. The above results are shown in Table 1.

TABLE 1

| | | | | | | | | CAPACITY | | RATE | | |
|---|---|---|---|---|---|---|---|---|---|---|---|---|
| | | SINGLE | | REACTION | | | | RETENTION | | CHARACTERISTIC | | |
| | | PHASE | | TEMPERATURE | | DISCHARGE | | RATE AFTER | | 5 C/0.5 CC | | |
| | | SYNTHESIS | | WITH SOLID | | CAPACITY | | 30 CYCLES | | CAPACITY | | |
| | | RATE | | ELECTROLYTE | | (mAh/cm²) | | (%) | | RATIO | | OVER- |
| | | RE- | | RE- | | RE- | | RE- | | RE- | | ALL |
| | COMPOSITION | SULT | JUDGE | SULT | JUDGE | SULT | JUDGE | SULT | JUDGE | SULT | JUDGE | JUDGE |
| EXAMPLE 1 | Al₂Nb₄₅Ta₅O₁₂₈ | 100% | ∘ | 700° C. | ∘ | 1145 | ∘ | 91.3 | ∘ | 73.3% | ∘ | ∘ |
| EXAMPLE 2 | Al₂Nb₄₀Ta₁₀O₁₂₈ | 100% | ∘ | 710° C. | ∘ | 1063 | ∘ | 94.8 | ∘ | 75.1% | ∘ | ∘ |
| EXAMPLE 3 | AL₂Nb₃₅Ta₁₅O₁₂₈ | 90% | ∘ | 720° C. | ∘ | 1049 | ∘ | 94.4 | ∘ | 74.6% | ∘ | ∘ |
| COMPAR- | Al₂Nb₅₀O₁₂₈ | 100% | ∘ | 640° C. | x | 1312 | ∘ | 88.4 | x | 68.7% | x | x |
| ATIVE | | | | | | | | | | | | |
| EXAMPLE 1 | | | | | | | | | | | | |
| COMPAR- | Al₂Nb₃₀Ta₂₀O₁₂₈ | 46% | x | 720° C. | ∘ | 342 | x | 68.5 | x | 47.6% | x | x |
| ATIVE | | | | | | | | | | | | |
| EXAMPLE 2 | | | | | | | | | | | | |

As shown in Table 1, in all of Examples 1 to 3, the overall judgment was judged as acceptable “∘”. This is thought to be because the anode active material having the compositional formula Al₂Nb₅₀₋ₓMₓO₁₂₈ (0<x<20) was used.

### Example 4

The raw materials were weighed to give a composition ratio of Al₂Nb₄₀Ta₁₀O₁₂₈ and mixed. After mixing, the mixture was calcined at 1000° C. in the normal atmosphere, the obtained calcined powder was again crushed, and then heated at 1300° C. in the normal atmosphere to obtain the desired synthetic powder of Al₂Nb₄₀Ta₁₀O₁₂₈. After the synthetic powder was again crushed, it was sieved through a stainless steel mesh of #150 to form an anode active material powder.

The powder of Li₁₊ₓAlₓGe₂₋ₓ(PO₄)₃ was uniformly dispersed in an aqueous or organic solvent together with a binder, a dispersant, a plasticizer and so on, and then wet grinding was performed to obtain a solid electrolyte slurry having a desired average particle size and was then applied to obtain a solid electrolyte green sheet. Thereafter, a paste containing the cathode active material powder was printed on the solid electrolyte green sheet. A paste containing the anode active material powder was printed on another solid electrolyte green sheet. After printing, a plurality of solid electrolyte green sheets were alternately stacked and fired.

### Comparative Example 3

The raw materials were weighed to give a composition ratio of Al₂Nb₅₀O₁₂₈ and mixed. The other conditions were the same as in Example 4.

The discharge capacity and the cycle characteristic were examined using the same methods as Examples 1 to 3 and Comparative Examples 1 and 2. Table 2 shows the results. Here, if the discharge capacity is 700 mAh/cm³ or more, the discharge capacity was judged as acceptable “∘”. In Example 4, a discharge capacity of 731 mAh/cm³ was obtained. Therefore, in Example 4, the discharge capacity was judged as acceptable “∘”. Furthermore, if the capacity retention rate after 30 cycles is 80% or more, the capacity retention rate was judged as acceptable “o”. In Example 4, a capacity retention rate of 88.7% was obtained. Therefore, in Example 4, the cycle characteristic was judged as acceptable “∘”. On the other hand, in Comparative Example 3, no battery operation was achieved, and the discharge capacity and the cycle characteristic could not be measured. This is thought to be because Al₂Nb₅₀O₁₂₈ reacted with the solid electrolyte during the firing, increasing the resistance of the cell or forming of other compounds.

TABLE 2

| | | | | CAPACITY | | |
|---|---|---|---|---|---|---|
| | | | | RETENTION | | |
| | | DISCHARGE | | RATE AFTER | | |
| | | CAPACITY | | 30 CYCLES | | |
| | | (mAh/cm²) | | (%) | | OVERALL |
| | COMPOSITION | RESULT | JUDGE | RESULT | JUDGE | JUDGE |
| EXAMPLE 4 | Al₂Nb₄₀Ta₁₀O₁₂₈ | 731 | ∘ | 88.7 | ∘ | ∘ |
| COMPARATIVE | Al₂Nb₅₀O₁₂₈ | NO | x | NO | x | x |
| EXAMPLE 3 | | OPERATION | | OPERATION | | |

Although the embodiments of the present invention have been described in detail, it is to be understood that the various change, substitutions, and alterations could be made hereto without departing from the spirit and scope of the invention.

1. An electrode active material comprising:
an anode active material that is expressed as a composition formula of Al₂Nb₅₀₋ₓMₓO₁₂₈ in which x satisfies 0<x<20 and M is a transition metal element of which a valence is 5 or more.

2. The electrode active material as claimed in claim 1,
wherein x satisfies 3≤x.

3. The electrode active material as claimed in claim 1,
wherein x satisfies 5≤x.

4. The electrode active material as claimed in claim 1,
wherein x satisfies x≤18.

5. The electrode active material as claimed in claim 1,
wherein x satisfies 5≤x≤15.

6. The electrode active material as claimed in claim 1,
wherein the anode active material is contained 80% or more by volume.

7. The electrode active material as claimed in claim 2,
wherein M is tantalum.

8. The electrode active material as claimed in claim 1,
wherein the electrode active material is a powder material before firing.

9. The electrode active material as claimed in claim 1,
wherein, when X-ray diffraction analysis is performed on the electrode active material, a peak appears in a range of 25.3° or more and 25.7° or less.

10. The electrode active material as claimed in claim 9,
wherein, when X-ray diffraction analysis is performed on the electrode active material, X-ray diffraction intensity in a range of 25.8° or more and 26.1° or less is 1/15 or less of X-ray diffraction intensity in the range of 25.3° or more and 25.7° or less.

11. An all solid battery comprising:
an oxide-based solid electrolyte layer;
a first electrode layer that is provided on a first main face of the oxide-based solid electrolyte layer and includes a cathode active material; and
a second electrode layer that is provided on a second main face of the oxide-based solid electrolyte layer and includes the electrode as claimed in claim 1.
